(19) United States
(12) Patent Application Publication
(10) Pub. No.: US 2025/0027212 A1
(43) Pub. Date: Jan. 23, 2025

(54) ELECTROLYSIS SYSTEM INCLUDING AT LEAST ONE CAPACITIVE HALF-CELL

(71) Applicant: CAPLYZER AB, Vallingby (SE)

(72) Inventors: Joydeep Dutta, Vallingby (SE); Esteban Alejandro Toledo Carrillo, Stockholm (SE)

(21) Appl. No.: 18/716,134

(22) PCT Filed: Dec. 7, 2022
(86) PCT No.: PCT/EP2022/084778

§ 371 Date: Jun. 3, 2024

(30) Foreign Application Priority Data
Dec. 7, 2021 (SE) 2151488-0

(51) Int. Cl. C25B 9/70; C25B 1/04; C25B 15/08

(52) U.S. Cl. CPC C25B 9/70; C25B 15/08; C25B 1/04

(57) ABSTRACT

An electrochemical system comprising at least one half-cell (1, 100) adapted for holding a first electrolyte, a first electrocatalyst (10) arranged on a current collector (11) forming a first working electrode, and a first auxiliary electrode material (12) arranged on a second current collector (13), and optionally a second half-cell (2, 200) adapted for holding a second electrolyte, a second electrocatalyst (20) arranged on a current collector (21) forming a second working electrode, and a second auxiliary electrode material (20) arranged on a current collector (21), wherein the working electrode and the auxiliary electrode are connected to an external circuit including a power supply (300) and a control unit (400), and wherein the polarity of the power supply determines whether the working electrode acts as a cathode or an anode, thus creating a cathodic or an anodic half-cell. A method for electrochemical production of chemicals and gases, in particular hydrogen, using said cell or system of cells.

### TECHNICAL FIELD

The present disclosure relates in general to systems and methods for performing electrolytic processes e.g. for the production of chemicals and gases, and in particular to an electrochemical half-cell and electrochemical systems with one or more separated reactors or half-cells.

### BACKGROUND

Electrolysis, the separation of positively and negatively charged materials by application of an electric current, has many practical uses, for example in the chemical and metallurgical industry. Electrolysis can be used for the purification of metals, for electroplating, and for example for the production of bulk chemicals such as but not limited to sodium chlorate (NaClO₃) and gases such as but not limited to chlorine (Cl₂), fluorine (F₂), oxygen (O₂) and hydrogen (H₂) gas.

When an aqueous sodium chloride solution (brine) is subjected to a current, gaseous chlorine and hydrogen is formed, and sodium hydroxide accumulates in the solution. Similarly, calcium fluoride, an abundant mineral, can be dissolved in sulfuric acid and subjected to electrolysis, producing gaseous fluoride and hydrogen.

In the present disclosure, the main focus is on electrolysis when used for the production of gases but features of the disclosure are also applicable to other aspects of electrolysis. The production of gases is used herein as an example without intention to limit the scope of the present disclosure.

There is a currently a considerable interest in the production of hydrogen due to a growing global demand for hydrogen gas. The main uses of hydrogen include fixation of nitrogen in the production of fertilizers, de-sulfurization of crude oil in refineries, decarbonization of steel making processes, hydrogenation of oils and fats in the food industry, transportation fuel and as a raw material for chemical synthesis, for example for the production of hydrogen peroxide. Currently fossil fuels, and in particular natural gas, remains the main source of hydrogen. In a process referred to as steam-methane reforming, pressurized high-temperature steam reacts with methane in the presence of a catalyst to produce hydrogen, carbon monoxide, and a relatively small amount of carbon dioxide. There is however a growing consensus that the use of fossil fuels must be reduced.

Hydrogen is abundant in water, and electrolysis is a promising option for carbon-free hydrogen production. Electrolysis nevertheless accounts only for a very small part of the hydrogen production as about 95% of the world's hydrogen is produced using the steam methane reforming process. If the electricity is produced using renewable resources, hydroelectric power, photovoltaics or wind power, or nuclear power, electrolysis would offer a practically carbon-free source of hydrogen. The hydrogen thus produced can then be used as a fossil-free and practically emission free fuel, in addition to the traditional uses in the chemical industry. Additionally, the hydrogen formed in the electrolysis of water is extremely pure (>99.9%) which is a requirement if the hydrogen is to be used in fuel cell applications, such as fuel cell powered vehicles, as some contaminants reduce the performance of the fuel cell already at very low concentrations.

Hydrogen production by electrolysis is—according to currently available technologies—generally performed in a single electrochemical cell where all the components of the system are connected in a closed electrical circuit to allow two reactions to take place simultaneously in the same electrochemical cell, namely the hydrogen evolution reaction (HER) at the cathode and the oxygen evolution reaction (OER) at the anode.

The process can involve the use of either acidic or basic media (electrolytes), whereof acidic electrolytes are generally favourable as the abundance of protons in acidic solution provides H+ to react on the surface of the cathode, forming hydrogen gas. The reaction kinetics however suffer, as the efficiency of OER is reduced in acidic media. Conversely, the efficiency of HER is reduced in alkaline media. The stability of the electrocatalysts, the cathode and the anode, can suffer in both acidic and alkaline electrolytes, making it a challenge to find the right materials.

Moreover, hydrogen and oxygen can form explosive mixtures, so hydrogen and the oxygen produced during electrolysis need to be further separated into different chambers. This is often achieved by the use of membranes that allow the diffusion of H+ or OH− to close the electrical circuit in acidic or alkaline electrolyser, respectively.

The first decoupled system was proposed by Symes et al, in 2013, based on the use of a redox mediator (electron-coupled-proton buffer, ECPB) to separate HER and OER in time. The system consists of two compartments separated by a semipermeable membrane so that only protons can diffuse between the two chambers. A platinum electrode is used as catalyst for OER and HER (working electrode), as well as for the reversible reaction of the ECPB (counter electrode). This design is based on a two-stage process whereby the oxygen is produced while the ECPB is reduced. Consecutively, the external power is reversed and the ECPB is oxidized while the working electrode produces hydrogen. Considering this strategy, half of the time needed is consumed during the production of oxygen. Additionally, this design requires the use of molecular selective membranes to provide a barrier for the gases produced during the process, preventing the formation of a potentially dangerous mixture of gasses.

More recently, similar systems have been proposed to replace the buffer redox mediator by a solid-state redox mediator, mainly for the NiOOH/Ni(OH)₂. (Dotan et al., 2019; Yan et al., 2021). Thus the use of a membrane is not needed since the use of bifunctional catalysts and cyclically alternating polarity allows continuous but separate formation and collection of hydrogen and oxygen.

However, such systems require the use of expensive active electrocatalysts to reduce the energy consumption during the process, and also to withstand the aggressive electrolytes used in the process. Additionally, quite extensive auxiliary equipment is required to handle sequential supply and change of electrolytes and the collection of gases.

US 2021/0180197 presents a system including a pair of electrolytic cells for accommodating water supplied from an electrolytic water tank and connected to a hydrogen tank and an oxygen tank, a pair of active electrodes including a cathode and an anode being accommodated in the electrolytic cells and connected to electric power by an active electrode lead to electrolyze electrolytic water to produce hydrogen and oxygen, auxiliary electrodes accommodated in the electrolytic cells and connected by an auxiliary electrode lead to provide electrons to the separated electrolytic cells or receive electrons therefrom, sensors for measuring pressure of hydrogen or oxygen generated in the electrolytic cells and measure electrolytic water capacity of the electrolytic cells, and a controller for selectively discharging a hydrogen or oxygen gas upon receiving a measurement value of a sensor, selectively supplying electrolytic water to the electrolytic cells from the electrolytic water tank, and selectively controlling a current direction of the electric power.

CN 109680293 appears to disclose an electrolytic half-cell comprising two current collectors that each can be made of metal, such as gold, platinum, graphite, titanium, nickel, and stainless steel, and a capacitor electrode body closely attached to one side or both sides of the first current collector. The disclosure is however focused on a batch-wise operation, and silent on the concept of capacitive build-up and how the cell would be operated in an efficient fashion.

WO2013019427A1 teaches positioning a first capacitive electrode and a first non-capacitive electrode in a first aqueous solution comprising at least one of sodium chloride, potassium chloride, sodium bromide and potassium bromide; applying a first electrical current on the first capacitive electrode and the first non-capacitive electrode to electrolyse the first aqueous solution to generate at least one of chlorine and bromine, while the first capacitive electrode acts as cathode and the first non-capacitive electrode acts as anode; applying a second electrical current on the first capacitive electrode and the first non-capacitive electrode to electrolyse the first aqueous solution to generate hydrogen, while the first capacitive electrode acts as anode and the first non-capacitive electrode acts as cathode; and switching polarities of the first capacitive electrode and the first non-capacitive electrode before the first capacitive electrode is fully occupied.

US20050126924 discloses, as one embodiment, a unipolar electrolysis for the generation of hydrogen, but does not mention the possibility of shifting polarities and discharging the capacitive build-up in the half-cell.

It remains a challenge to further improve the equipment and methods for performing electrolysis, and in particular the technology for the production of gases by electrolysis, maintaining high levels of safety and simultaneously improving the performance and sustainability of the systems, and in particular to reduce energy consumption.

### SUMMARY

One aim of the present disclosure is to make available an improved system for electrolytic production of chemicals, in particular gases, such as but not limited to hydrogen, fluoride, and oxygen, also including electrolytic processes for other purposes, but where these and/or other gases are formed as biproducts. Further aims and the corresponding solutions and their associated advantages will appear from the description and examples.

Thus, a first aspect of the present disclosure relates to an electrochemical system comprising at least one half-cell adapted for holding an electrolyte, an electrocatalyst arranged on a current collector forming a working electrode, and an auxiliary electrode material arranged on another current collector forming an auxiliary electrode;
wherein the working electrode and the auxiliary electrode are connected to a power supply and a control unit, forming a closed circuit, said system further comprising an at least one electrolyte reservoir, adapted for holding said electrolyte, at least one pump for circulating said electrolyte between said half-cell and said reservoir, and at least one container for collecting gas formed in the electrolytic half-cell,
and wherein the polarity of the power supply determines whether the working electrode acts as a cathode or an anode, thus creating a cathodic or an anodic half-cell.

According to an embodiment of said first aspect, this electrochemical system comprises a first half-cell adapted for holding a first electrolyte, a first electrocatalyst arranged on a current collector forming a first working electrode, and a first auxiliary electrode material arranged on a second current collector forming a first auxiliary electrode; and
a second half-cell adapted for holding a second electrolyte, a second electrocatalyst arranged on a current collector forming a second working electrode, and a second auxiliary electrode material arranged on a current collector forming a second auxiliary electrode;
wherein the working electrodes are connected to an external circuit including a power supply, and a control unit, and the auxiliary electrodes are connected to each other, forming a closed circuit, said system further comprising at least a first and second electrolyte reservoir, a first and a second pump for circulating a first electrolyte between said first half-cell and said first reservoir, and circulating a second electrolyte between said second half-cell and said second reservoir, and a first and a second container for collecting gas formed in each electrolytic half-cell respectively.

According to another embodiment of said first aspect, said system comprises at least one conduit or bypass for diverting gas formed during the decharging phase.

According to another embodiment of said first aspect, freely combinable with the above, the control unit comprises circuitry for controlling and optionally registering the polarity, voltage, current and/or duration of the applied power.

According to yet another embodiment of said first aspect, freely combinable with the above, the control unit further comprises circuitry for controlling and optionally registering the flow of electrolyte, temperature, and/or pressure.

According to another embodiment of said first aspect, freely combinable with the above, the auxiliary electrode material comprises an electrochemically inactive material chosen from capacitive materials, such as a material with good electric conductivity, chemical resistivity towards various electrolytes and extremely high specific surface area.

According to another embodiment of said first aspect, freely combinable with the above, the electrochemically inactive material is made of a porous carbon material, preferably chosen from activated carbon materials, such as activated carbon electrode materials such as activated carbon cloth, a porous graphite sheet, mesoporous carbon, and porous graphite acting in addition as a gas permeable layer. The choice of a material from this list has surprisingly shown to giving the advantage of the electrode acting also as a gas diffusion layer or porous transport layer for the flow of electrolyte and gas through the cell, improving the performance of the cell.

According to another embodiment of said first aspect, freely combinable with the above, the spacer is made of an electrically insulating material and permeable to the electrolyte.

Another aspect of the present disclosure relates to a method for electrochemical production of a gas using at least one half-cell each comprising a working electrode and an auxiliary electrode connected to a power supply, forming a closed circuit, said system further comprising at least one electrolyte reservoir, at least one pump for circulating electrolyte between said half-cell and said reservoir, and at least one container for collecting gas formed in an electrolytic half-cell, wherein the polarity of the working electrode is shifted through consecutive cycles of charging and discharging the half-cell, wherein an electrolyte is pumped into said at least one half-cell and circulated between said half-cell and a reservoir, voltage is applied to at least one half-cell, and gas formed in said electrolyte is separated and collected.

According to an embodiment of said second aspect, the method is performed by separately circulating two between a first reservoir and a first half-cell and a second reservoir and a second half-cell respectively, wherein a gas evolving in a first electrolyte and a gas evolving in the second half-cell are collected separately. When performing the method, the polarity of the power supply determines which of the working electrodes acts as a cathode or an anode, thus creating a cathodic and an anodic half-cell. During operation, the polarity can be reversed.

According to another embodiment of said second aspect, freely combinable with the above, the two electrolytes are maintained at different pH.

According to yet another embodiment of said second aspect, freely combinable with the above, a gas produced by the method is chosen from hydrogen, chlorine, oxygen, and fluorine.

According to another embodiment of said second aspect, freely combinable with the above, the gas produced by the method is hydrogen.

According to another embodiment of said second aspect, freely combinable with the above, hydrogen and oxygen are produced in parallel. In a preferred embodiment, the cells are operated intermittently to produce oxygen and hydrogen, and wherein the mixing of hydrogen and oxygen is prevented by collecting gas formed during the decharging phase separately from gas formed during the charging phase.

Further aspects and embodiments will be apparent from the detailed description, examples and attached drawings.

### BRIEF DESCRIPTION OF THE DRAWINGS

The invention and embodiments thereof will now be described, by way of non-limiting examples, and with reference to the accompanying drawings, in which:

FIG. 1 is a schematic representation of an electrochemical processes taking place on each electrode in a system comprising two half cells 1 and 2, where a hydrogen evolution reaction (HER) takes place on the electrocatalyst material 10 in the cathodic half-cell 1, and an oxygen evolution reaction (OER) takes place on the electrocatalyst material 20 in the anodic half-cell 2. The electrocatalyst materials 10 and 20 are arranged on current collectors 11 and 21 respectively, forming so called working electrodes. An auxiliary electrode 12 is present in the cathodic cell, and an auxiliary electrode 22 in the anodic cell. The auxiliary electrodes 12 and 22 are made of electrochemically inactive material and arranged on current collectors 13 and 23 respectively.

FIG. 2 schematically shows the major components of an electrochemical system according to an embodiment of the invention, with a cathodic half-cell (CHC) 100 and an anodic half-cell (AHC) 200 surrounded by auxiliary equipment as described in association with the detailed description and examples.

FIG. 3 is a cross section schematically showing the components of a half-cell 100, 200 comprising a first current collector 11, 21 on which an electrocatalyst material 10, 20 is arranged. An auxiliary electrode 12, 22 is arranged on second current collector 13, 23. The electrodes are separated by an electrically insulating layer 30, permeable to the electrolyte, for example but not limited to filter paper.

FIG. 4 is a diagram showing the cell voltage (V) profile as a function of time(s) recorded during two consecutive electrocatalytic cycles (charge-discharge) using graphite electrodes in a prototype system as disclosed in Example 1. The cell voltage recorded during multiple consecutive cycles is shown in FIGS. 10 and 15 presented further below.

FIG. 5 is a diagram showing the amount of dissolved hydrogen (μmol/L) and dissolved oxygen (mg/L) detected in the liquid phase in the catholyte reservoir (5M KOH) during a 40 min operation of a prototype system as disclosed in Example 1.

FIG. 6 is a diagram showing the theoretical (solid line) and experimental (dashed line) hydrogen production (mmol) at a Faradaic efficiency of 94% for the assembly using graphite as electrocatalyst, the material of the working electrodes, in a prototype as disclosed in Example 1.

FIG. 7 is a diagram showing the cell voltage (V) profile as a function of time(s) along the electrocatalytic cycles using NiCOS electrodes in a prototype system as disclosed in Example 2.

FIG. 8 is a diagram showing the amount of dissolved hydrogen (μmol/L) and dissolved oxygen (mg/L) detected in the liquid phase in the catholyte reservoir (5M KOH) during a 40 min operation of a prototype system with NiCOS as electrocatalyst as disclosed in Example 2.

FIG. 9 is a diagram showing the theoretical (solid line) and experimental (dashed line) hydrogen production at a Faradaic efficiency of 80% for the assembly using NiCOS as electrocatalyst in a prototype system as disclosed in Example 2.

FIG. 10 is a diagram showing the cell voltage profile along the electrolytic production of hydrogen using a single half-cell as disclosed in Example 3.

FIG. 11 is a diagram showing the theoretical (solid line) and experimental (dashed line) hydrogen production at an overall Faradaic efficiency of 69% for the assembly using Ni foam as electrocatalyst in KOH 5M using a single cell configuration as disclosed in Example 3.

FIG. 12 is a schematic representation of a unipolar (either cathodic or anodic) electrochemical half-cell, here exemplified by a cathodic half-cell 1, where a hydrogen evolution reaction (HER) takes place on the electrocatalyst material 10 arranged on a current collector 11, opposite an auxiliary electrode formed by an electrochemically inactive material 12 arranged on a second current collector 13, connected via a control unit 400 to a power supply 300 forming a closed electric circuit. The polarity of the power supply determines whether the working electrode acts as a cathode or an anode, thus creating a cathodic or an anodic half-cell. The control unit 400 comprises circuitry for controlling and optionally registering the polarity, voltage, current and/or duration of the applied power. The control unit 400 further comprises circuitry for controlling and optionally registering the flow of electrolyte, temperature, and/or pressure. The control unit may also register variations in voltage and current while the potential is applied or after it is cut off, as well as including safety features, such as automatically disconnecting the supply of power if irregularities in e.g. pressure or temperature is/are detected.

FIG. 13 is a diagram showing the cell voltage (V) profile as a function of time(s) for different current densities applied to the cell assembled using Pt-coated Ti as electrocatalyst. The current densities go from 5 mA/cm² to 50 mA/cm² in increments of 5 mA/cm².

FIG. 14 is a diagram showing the calculated energy consumption of the electrolytic cell as a function of the input current density applied to the cell assembled using Pt-coated Ti as electrocatalyst.

FIG. 15 is a comparative diagram showing the cell voltage (V) profile as a function of time(s) for different current densities applied to the cell assembled using Pt-coated Ti as electrocatalyst, with 1M KOH and 1M H₂SO₄ as electrolyte.

### DETAILED DESCRIPTION

The present invention will be described below with reference to the accompanying drawings and certain exemplifying embodiments. The invention is however not limited to the embodiments shown but can be varied within the scope of the appended claims. Moreover, the drawings shall not be considered to be drawn to scale as some features may be simplified, exaggerated, or distorted in order more clearly illustrate the features of the device(s) or details thereof.

Before the present invention is described, it is to be understood that the terminology employed herein is used for the purpose of describing particular embodiments only and is not intended to be limiting, since the scope of the present invention will be limited only by the appended claims and equivalents thereof.

It must be noted that, as used in this specification and the appended claims, the singular forms “a,” “an,” and “the” include plural referents unless the context clearly dictates otherwise.

The term “decoupled” as in “decoupled electrolysis” is used to describe a system where the generation of hydrogen (hydrogen evolution reaction, HER) and oxygen (oxygen evolution reaction, OER) takes place cells separated in space or time. Traditionally the cathodic and anodic cells are separated by a membrane, but in the present disclosure, no membrane is used, as the cells are physically separated while electrically connected. When the system operates using two cells, both the reactions will take place at the same time, but in separated cells (spatially decoupled). However, when the system is operated using only one cell, the reactions will take place at different times (during the charging and discharging cycles), since the active electrode will produce hydrogen during the first step and oxygen in the next step.

When using the expression “different chemical composition” it is indicated that for example two or more solutions comprise different ions, or the same ions in different concentrations, or simply that the two or more solutions have different pH.

The terms “auxiliary electrode” and “secondary electrode” are used to define conductive material connected to a power source and in contact with the content of an electrolytic cell, here a half-cell. Electrodes can be of any shape and size, and be positioned inside a half-cell, or form part of the inner surface of a half-cell.

The term “capacitive” is used to describe the property of a material to store charged species by formation of an electrochemical double layer.

The term “electrochemically inactive” is used to define a material which is inactive towards the opposite reaction in an electrochemical cell, that is electrochemically inactive towards HER and OER in the operational voltage window, for example within a range of −2 to +2 V. In the example of the electrolysis of water, the auxiliary electrode opposite to the cathode shall be made of a material which doesn't support the corresponding anodic reaction, i.e. it is electrochemically inactive.

The term “activated carbon materials” is used to describe any carbon-based material having increased surface area available for adsorption or chemical reactions. Activated carbon can be agglomerated and formed into a variety of shapes, such as sheets, briquettes, rods etc., and also knitted or woven into activated carbon cloth.

When using the term “separate” as in “two separate half-cells . . . ” it is intended that there is no chemical interaction between the content of the half-cells, i.e. that the content of one half-cell does not interact chemically with the content of another half-cell.

Thus, a first aspect of the present disclosure relates to
Thus, a first aspect of the present disclosure relates to an electrochemical system comprising at least one half-cell adapted for holding an electrolyte, an electrocatalyst arranged on a current collector forming a working electrode, and an auxiliary electrode material arranged on another current collector forming an auxiliary electrode;
wherein the working electrode and the auxiliary electrode are connected to a power supply and a control unit, forming a closed circuit, said system further comprising an at least one electrolyte reservoir, adapted for holding said electrolyte, at least one pump for circulating said electrolyte between said half-cell and said reservoir, and at least one container for collecting gas formed in the electrolytic half-cell,
and wherein the polarity of the power supply determines whether the working electrode acts as a cathode or an anode, thus creating a cathodic or an anodic half-cell.

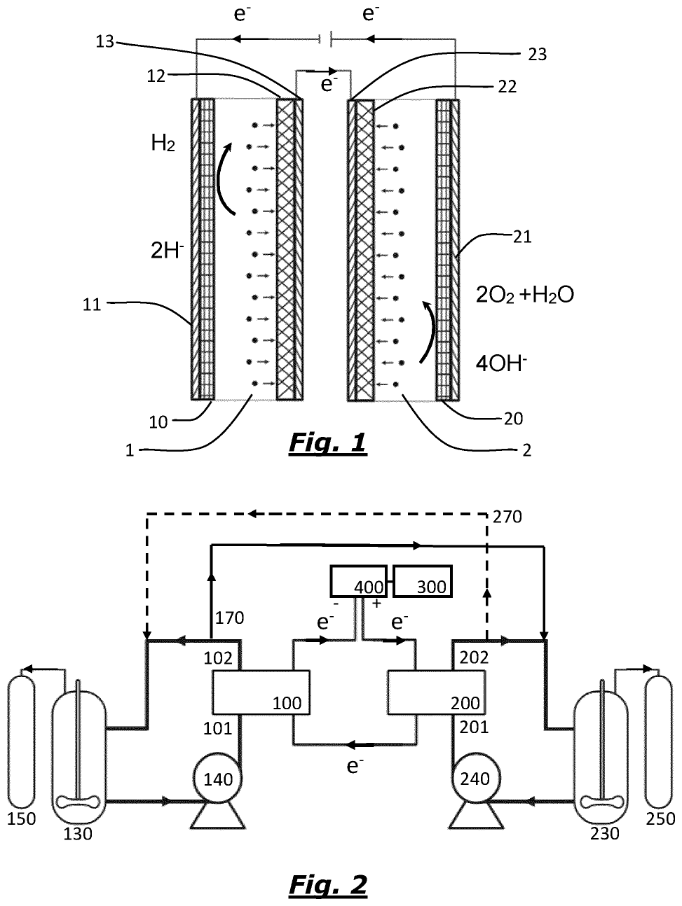

This is schematically illustrated in FIGS. 1 and 2, where an electrochemical system comprising at least one half-cell 1, 100 adapted for holding an electrolyte, an electrocatalyst 10 arranged on a current collector 11 forming a working electrode, and an auxiliary electrode material 12 arranged on another current collector 13 forming an auxiliary electrode;
wherein the working electrode and the auxiliary electrode are connected to a power supply 300 and a control unit 400, forming a closed circuit, said system further comprising an at least one electrolyte reservoir 130, adapted for holding said electrolyte, at least one pump 140 for circulating said electrolyte between said half-cell 1, 100 and said reservoir 130, and at least one container 150 for collecting gas formed in the electrolytic half-cell.

According to an embodiment of said first aspect, this electrochemical system comprises a first half-cell adapted for holding a first electrolyte, a first electrocatalyst arranged on a current collector forming a first working electrode, and a first auxiliary electrode material arranged on a second current collector forming a first auxiliary electrode; and
a second half-cell adapted for holding a second electrolyte, a second electrocatalyst arranged on a current collector forming a second working electrode, and a second auxiliary electrode material arranged on a current collector forming a second auxiliary electrode;
wherein the working electrodes are connected to an external circuit including a power supply, and a control unit, and the auxiliary electrodes are connected to each other, forming a closed circuit, said system further comprising at least a first and second electrolyte reservoir, a first and a second pump for circulating a first electrolyte between said first half-cell and said first reservoir, and circulating a second electrolyte between said second half-cell and said second reservoir, and a first and a second container for collecting gas formed in each electrolytic half-cell respectively.

This embodiment is illustrated in FIG. 2, showing a first half-cell 100 having an inlet 101 and an outlet 102 for allowing the input of a first electrolyte into the half-cell, and for allowing the output of gas evolving in said half-cell, and/or the circulation of electrolyte containing said gas in the form of bubbles or in dissolved form. Preferably said electrochemical system comprises a pump 140 for circulating the first electrolyte between an electrolyte reservoir 130, for example a tank equipped with a stirrer, and the half-cell. Gas that evolves in the half-cell is transported with the first electrolyte and separated therefrom in the reservoir 130 and collected in a tank 150, for example. Similarly, a pump 240 is circulating a second electrolyte from a reservoir 230 via inlet 201 and outlet 202 through the second half-cell 200. The gas evolving in the second half-cell is transported with the electrolyte and separated therefrom in the reservoir 230 and collected in a tank 250. The tanks 150 and 250 are each designated for one particular gas, e.g. hydrogen and oxygen, and when the polarity is reversed, the bypass conduits 170 and 270 make it possible to avoid the mixing of gasses in that hydrogen is led to the hydrogen tank, and oxygen is led to the oxygen tank. The bypass arrangement is only schematically illustrated in FIG. 2 and a person skilled in the art will understand how to realize this in practice, with the necessary valves etc. An electrochemical system as disclosed herein will also comprise sensors for monitoring pressure, temperature, flow etc, not shown in the drawings. Similarly, valves and controls as well as customary safety valves, gas detectors etc will be included in particular when going into industrial scale. Again, a person skilled in the art will know how to take prevailing security regulations and good practice into account without departing from the principles disclosed herein.

According to another embodiment of said first aspect, said system comprises at least one conduit or bypass 170, 270 for diverting gas formed during the decharging phase.

According to another embodiment of said first aspect, freely combinable with the above, the control unit 400 comprises circuitry for controlling and optionally registering the polarity, voltage, current and/or duration of the applied power. Such circuitry, measuring equipment and corresponding sensors are commercially available, and a person skilled in the art will know how to apply these without departing from the principles disclosed herein.

According to yet another embodiment of said first aspect, freely combinable with the above, the control unit 400 further comprises circuitry for controlling and optionally registering the flow of electrolyte, temperature, and/or pressure. Again, such equipment commercially available, and a person skilled in the art will know how to apply these without departing from the principles disclosed herein.

According to another embodiment of said first aspect, freely combinable with the above, the auxiliary electrode material comprises an electrochemically inactive material such as a capacitive material, and more specifically chosen from materials having good electric conductivity, chemical resistivity towards the electrolyte used in the electrochemical process and high specific surface area.

According to another embodiment of said first aspect, freely combinable with the above, the electrochemically inactive material 12, 22 is made of a porous carbon material, preferably chosen from activated carbon materials, such as activated carbon electrode materials such as activated carbon cloth, a porous graphite sheet, mesoporous carbon, and porous graphite acting in addition as a gas permeable layer. The choice of a material from this list has surprisingly shown to give the advantage of the electrode acting also as a gas diffusion layer or porous transport layer for the flow of electrolyte and gas through the cell, improving the performance of the cell.

According to another embodiment of said first aspect, freely combinable with the above, the spacer is made of an electrically insulating material and permeable to the electrolyte.

In the attached practical examples, different examples are given of the voltage, current and/or duration applied in the operation of a system according to the present disclosure.

According to another embodiment of said first aspect, freely combinable with the above, the spacer 30 is permeable to the electrolyte and made of an electrically insulating material. Filter paper was used in the experimental set-up, but different porous electrically insulating materials can be used, such as polymer foams, mesh etc.

Another aspect of the present disclosure relates to a method for electrochemical production of a gas using a system comprising at least one half-cell adapted for holding an electrolyte, an electrocatalyst arranged on a current collector forming a working electrode, and an auxiliary electrode material arranged on another current collector forming an auxiliary electrode;
wherein the working electrode and the auxiliary electrode are connected to a power supply and a control unit, forming a closed circuit, said system further comprising an at least one electrolyte reservoir, adapted for holding said electrolyte, at least one pump for circulating said electrolyte between said half-cell and said reservoir, and at least one container for collecting gas formed in the electrolytic half-cell.

According to an embodiment of said second aspect, the system comprises two half-cells, connected to a power source as shown in FIG. 2, and in operation, one electrolyte is circulated between a first reservoir and a first half-cell, and a second electrolyte is circulated between a second reservoir and a second half-cell respectively, voltage is applied, and the gas evolving in the first electrolyte and the gas evolving in the second electrolyte is collected separately. The polarity of the power supply determines which of the working electrodes acts as a cathode or an anode, thus creating a cathodic and an anodic half-cell. During operation, the polarity can be reversed.

According to another embodiment of said second aspect, freely combinable with the above, the two electrolytes are maintained at different pH.

According to yet another embodiment of said second aspect, freely combinable with the above, the gas produced by the method is a gas chosen from hydrogen, chlorine, oxygen, and fluorine.

According to another embodiment of said second aspect, freely combinable with the above, the gas produced by the method is hydrogen.

According to another embodiment of said second aspect, freely combinable with the above, hydrogen and oxygen are produced in parallel.

The concept disclosed herein, i.e. the decoupled half-cells, has many advantages, one being the possibility to use dedicated electrolytes. The chemical composition of the catholyte and the anolyte can be optimized for the desired electrochemical reaction. For example HER is more efficient in acidic media, whereas OER is more efficient in alkaline media. It should also be mentioned that by using acidic and alkaline electrolytes in the two separated half-cells, the risk of side reactions, such as OER in the cathodic half-cell or HER in the anodic half-cell is significantly reduced, considering the low electrochemical activity of the capacitive materials used as the auxiliary electrodes.

Further, the choice of electrocatalyst materials for the working electrodes is simplified, and less expensive carbon-based materials can be used instead of expensive noble metals or alloys.

Another advantage is that the capacitive electrode, in particular when the electrode material is activated carbon cloth or similar, also acts as a gas diffusion layer avoiding hydrogen build-up inside the cell. As a consequence, the total hydrogen production capacity is improved. Additionally, as there is no remaining, trapped hydrogen, the risk of explosion during the oxygen production cycle can be avoided.

### EXPERIMENTAL

### Materials and Reagents

A prototype was assembled using commercial laboratory equipment where not otherwise stated. Zorflex® FM10 Activated carbon cloth (ACC) was supplied by Chemviron Carbon Ltd. (UK) and graphite sheet with a thickness of 0.18 mm was obtained from Mineral Seal Corporation (Minseal, US). Nickel foam (300×300 mm, thickness 1.6 mm, bulk density 0.45 g/cm³, porosity 95%) was acquired from Sigma-Aldrich and from Zopin Group, China. Sulfuric acid (H₂SO₄) 98% and potassium hydroxide (KOH) pellets used for the preparation of the electrolytes were acquired from Sigma-Aldrich.

### Construction of a Prototype

The prototype system was constructed as illustrated in FIG. 2. Two electrochemical half-cells 100 and 200 were connected to a DC power source 300 and a control unit 400 adapted for controlling the voltage, current, duration and polarity of the DC applied to the electrodes, and capable of recording these parameters. The circuit was closed by connecting the auxiliary electrodes of each half-cell, as shown in FIG. 2.

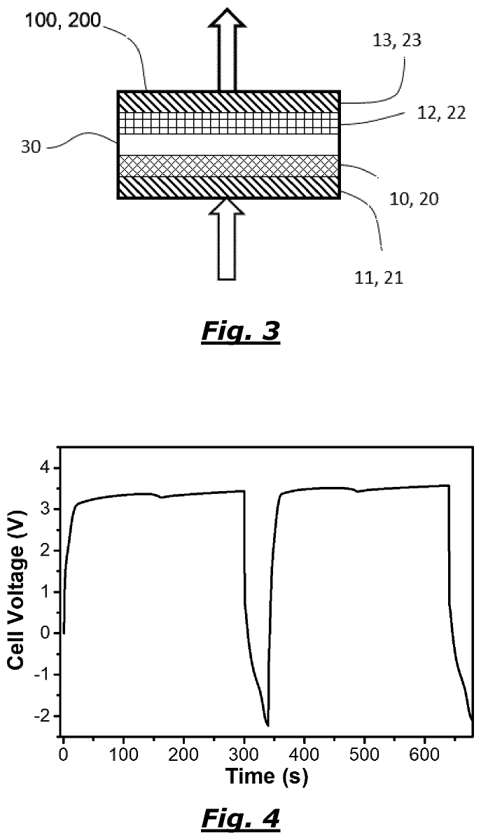

The prototype comprised an electrochemical system with two half-cells, namely the anodic half-cell (AHC) and the cathodic-half cell (CHC). As shown in FIG. 3, each half-cell assemblies were constructed with an active electrode 10, 20 (anode or cathode, 5×5 cm²) arranged on a current collector 11, 21, an inactive electrode 12, 22 (also referred to as secondary or auxiliary electrode, 5×5 cm²) arranged on a current collector 13, 23 (graphite sheets in this case) in direct contact with each electrode. The electrodes were separated by a porous insulating material 30, in this case filter paper, to avoid short circuit. The half-cells were sealed by a bottom endplate including an inlet channel (not shown), a top endplate including an outlet channel (not shown) and gaskets (not shown) to provide the inner space for the assembly, forming two separate cells, also called flat flow-through reactors.

The CHC 100 was supplied with acidic catholyte from a stirred catholyte reservoir 130 by a pump 140, in this example a peristaltic pump, and the catholyte reservoir 130 was vented into a hydrogen collection and storage vessel 150. Similarly, the AHC 200 was supplied with alkaline anolyte from a stirred anolyte reservoir 230 by a pump 240, and the anolyte reservoir 230 was vented into a hydrogen collection and storage vessel 250. In the experimental set-up, the gases formed were collected in laboratory glass flasks, where the volumes were calculated using the Archimedes method.

The electrolyte was fed into each half-cell by a peristaltic pump with a flow rate of 30 ml/min. Prior to each experiment, both electrolytes were purged with nitrogen gas for 20 min, to remove dissolved oxygen as much as possible. The electrolyte pumped into the CHC was 0.5M H₂SO₄ from a 200 ml catholyte reservoir, while a 1.0M KOH solution was fed into the AHC from a 200 ml anolyte reservoir. During the electrolysis process, a constant current of 10 mA/cm² was supplied by an external power supply 300, and a control unit 400 where the voltage profile was recorded by a digital multimeter Keithley 2110.

The external power was alternatively applied in order to achieve charging and discharging of the secondary electrodes. The cycle time was 5 minutes for the electrolysis, while the discharging was much faster, about 40 seconds. Hydrogen production was first detected in aqueous and gas phases using a H₂ measurement system (Unisense) with a needle sensor (2.1×80 mm) connected to a H₂ UniAmp unit (calibrated with hydrogen before use) and oxygen was detected in liquid phase by an Orion Star A213 Dissolved Oxygen benchtop meter (Thermo Fisher).

Later, the formed gases were led into flasks and the production quantified by the Archimedes method in order to obtain the volume produced during each cycle. The possible evolution of hydrogen in the AHC as a side reaction was evaluated in a separated test using the Unisense microsensor.

The theoretical hydrogen production and measured hydrogen volume was used to calculate the Faradaic efficiency for the HER following Equation I

$$Faradaic Efficiency ( \% ) = \frac{{n ( gas )}_{measured}}{{n ( gas )}_{theoretical}} = \frac{{PV ( gas )}_{measured} / RT}{Q / zF} \qquad Eq . I$$

where P is the pressure, V is the volume of the gas measured by Archimedes method, R is the gas constant, T is the temperature, Q is the charge provided to the system, z is the number of electrons transfer for the hydrogen evolution (2 electrons) and F is the Faraday constant.

### Example 1. Graphite as Active Material

A prototype decoupled electrolysis system was set up in a laboratory fume hood basically as shown in FIG. 2, and as presented above, with the exception that the gases evolved were not collected but vented through the fume hood exhaust.

The prototype comprised two flow-through flat reactors with a compartment of 5×5 cm in which the electrodes were assembled, separated by an isoelectric material. The construction of the half-cells is schematically shown in FIG. 3 where a flat flow cell is shown in cross section.

In this particular example, the half cells where assembled using graphite as bifunctional electrodes 10, 20 for the HER and OER, while Activated Carbon Cloth (ACC) was used as the secondary electrode 12, 22 in both half-cells, due to its high volumetric capacitance. The electrodes were separated by a layer of filter paper 30. The tests were performed with an acidic solution (0.5M H₂SO₄) in the cathodic compartment and an alkaline solution (1.0M KOH) in the anodic compartment in respective reactor.

The experiment was conducted at room temperature, and the acidic and alkaline electrolytes were circulated through the reactors at a flow rate of 30 ml/min. The process cycle consisted of a charging stage of 3-10 min and a discharging stage of 20-60 s, based on the voltage threshold.

FIG. 4 shows the cell voltage profile recorded during two consecutive cycles of charge and discharge in a non-optimized system. First, a rapid voltage build-up is seen. It is also clearly seen that the discharge phase is very short.

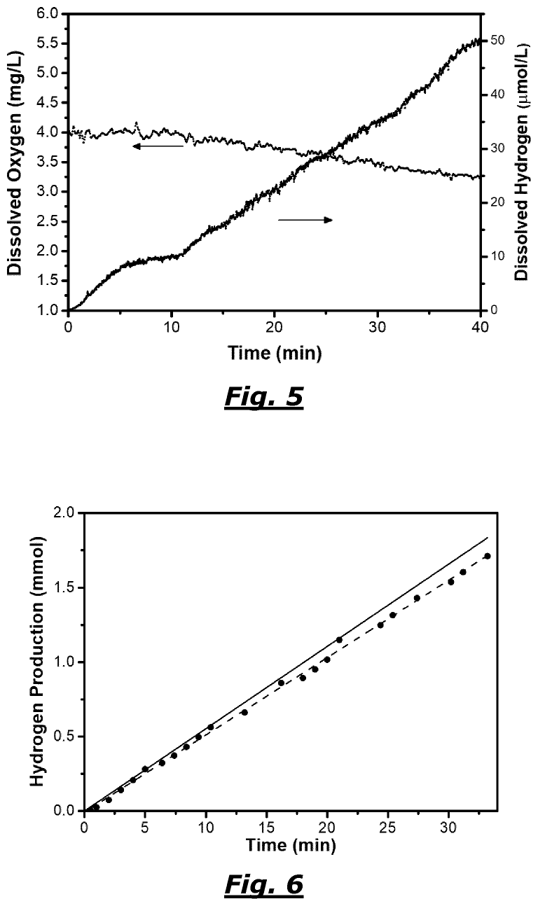

FIG. 5 shows the amount of dissolved hydrogen (μmol/L) and dissolved oxygen (mg/L) detected in the liquid phase in the catholyte reservoir (5M KOH) during a 40 min operation of the prototype system, corresponding to an efficiency of more than 90%. Is important to notice that no significant reduction in the production levels was recorded during the discharging stage, due to the short period needed for the discharging of the electrodes.

FIG. 6 shows the theoretical (solid line) and experimental (dashed line) hydrogen production at a Faradaic efficiency of 94% for the assembly using graphite as electrocatalyst. The Faradaic efficiency was calculated using equation 1 above.

### Example 2. Evaluation of NiCOS as Active Material

Similar to the previous example, the electrochemical devices were assembled using two layers of activated carbon cloth as auxiliary electrode in each half-cell and NiCOS as electrocatalyst in each half-cell. The NiCOS presents an excellent electrochemical activity for the anodic and cathodic reactions, with a good stability in both acidic and alkaline media, providing a cost-effective alternative to expensive noble metal-based catalysts. FIG. 7 shows the cell voltage during two consecutive charging/discharging cycles of hydrogen production. A clear reduction in the cell voltage is observed, as compared to the values obtained during hydrogen production with graphite electrodes.

A characteristic capacitive voltage rise is observed during the charging step, with an initial voltage of about 0.8 V, which clearly reveals the reduction in theoretical cell voltage (theoretical value for the acidic-alkaline system is 0.404 V). As compared to the graphite assembly, the reduction in cell voltage is ascribed to the lower overpotential for the HER and OER of NiCOS. The increase in the cell voltage over time is due to the accumulation of charges in the capacitive electrode. It suggests that the counter reactions (e.g. anodic reaction in the cathodic half-cell) are not suppressed, since there is a clear polarization of the capacitive electrode, and thus, the overpotential for the counter reaction is not reached.

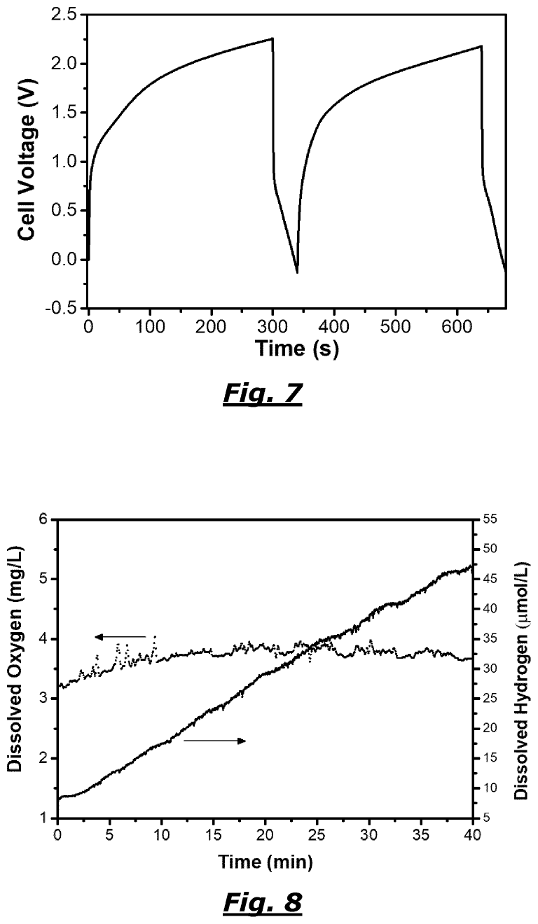

This was further confirmed by gas sensing in the catholyte half-cell, since hydrogen is clearly increasing at a constant rate and dissolved oxygen concentration is constant during the process. See FIG. 8.

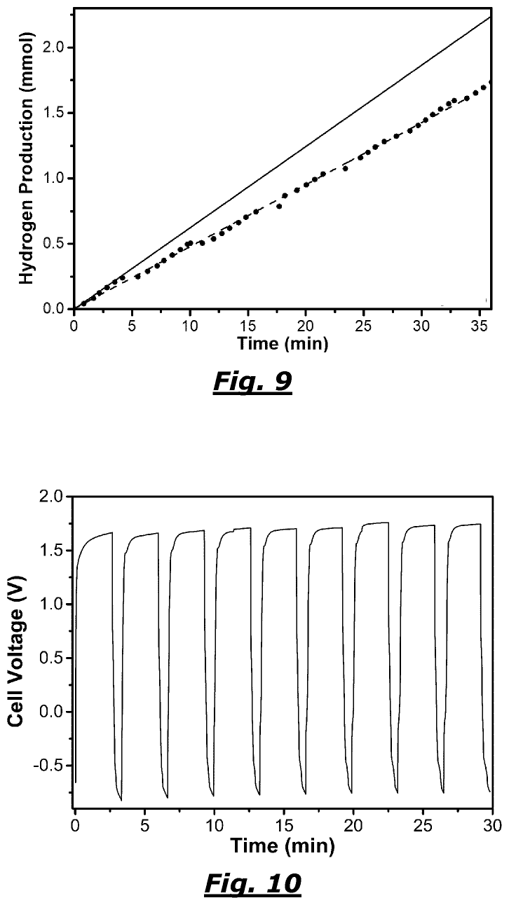

The hydrogen production was measured by determination of the volume added to the catholyte reservoir. The hydrogen production is shown in FIG. 9, for a continuous process during 35 min. A more detailed analysis reveals that the Faradaic efficiency during the charging step is about 95%, which is further reduced down to 80% efficiency of the overall process, due to longer times required for the discharging of the cell.

### Example 3: Hydrogen Production in Alkaline Media With a Single Cell Using Ni Foam as Active Material

A variation in the electrochemical system was tested by attempting hydrogen production using uniquely a cathodic half-cell (CHC) as shown in FIG. 12. The CHC was assembled using two layers of activated carbon cloth and Ni foam as active material. In this particular case, the hydrogen production in the CHC was carried out in alkaline media (KOH 5M).

FIG. 10 shows the cell voltage profile over 30 min operation with a cycling time of 160 seconds charging and 40 second discharging. A characteristic capacitive charging profile is observed during first cycle, reaching a cell voltage of 1.65V. Upon cycling, the charging and discharging step adopt a stepwise voltage profile, revealing the occurrence of a Faradaic reaction, which is most likely to be explain based in the reversible reactions taking place at the surface of the working electrode. Nonetheless, the maximum cell voltage reached over 9 consecutive cycles is constant.

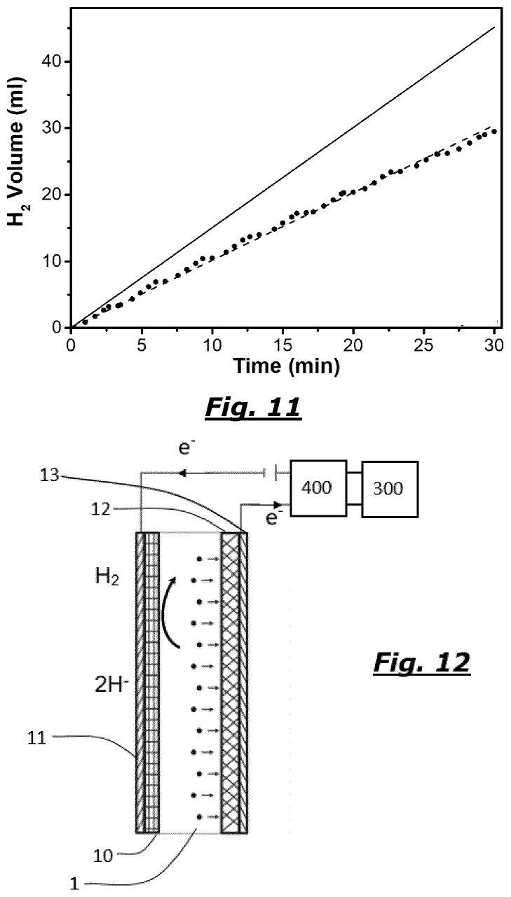

The volume of hydrogen produced was measured as shown in FIG. 11. The overall Faradaic efficiency—calculated according to Equation I—is about 69%. Similar to Example 2, the reduction in Faradaic efficiency is due to the different ratio between the charging and discharging time. The Faradaic efficiency during the charging step reached a maximum of 98%.

### Example 4. Single Cell Using Pt-Based Electrode

A single-cell system was set up using platinum coated titanium plate as working electrode and activated carbon cloth as auxiliary electrode with same configuration as shown in FIG. 12. The electrode area was 10×10 cm.

In this example, the cell was continuously fed with an acidic solution (1M H₂SO₄) from a 200 ml glass bottle reservoir at a rate of 30 ml/min.

The electrolysis process consists of 160 s of charging step and 40 s of discharging step.

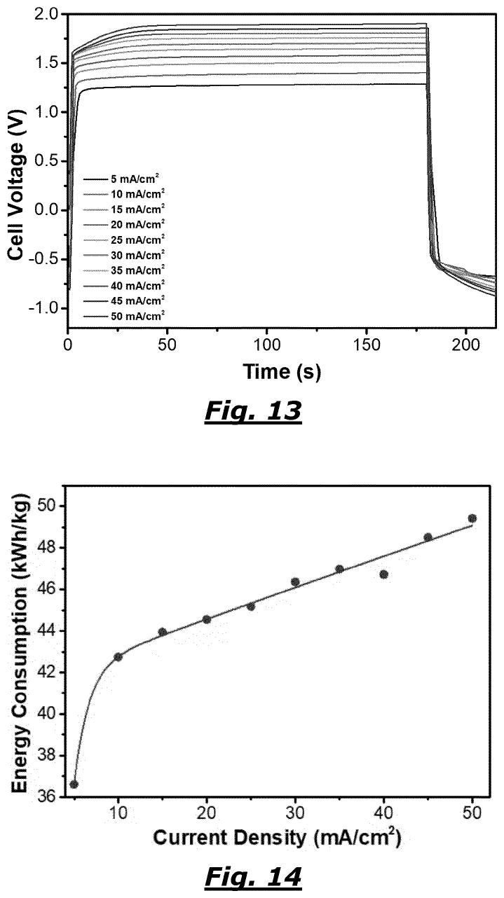

The cell was operated at different current densities, ranging from 5-50 mA/cm². FIG. 13 shows the voltage profile acquires for each current density.

Based on the I-V characteristics, the energy consumption was calculated for different current densities, as shown in FIG. 14. It shows the scalability of the system in terms of energy input and the production of hydrogen, validating its applicability at industrial levels.

It can be observed that the increase in energy consumed present a linear behaviour in the range between 10-50 mA/cm², indicating a significant influence of the series resistance across the cell.

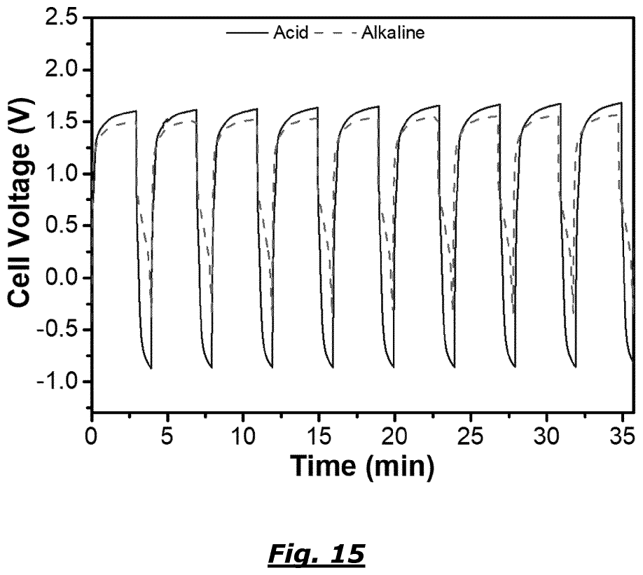

Identical set up was used to conduct experiments in alkaline media (1M KOH) to further prove the mechanism of reaction in both alkaline and acidic media. FIG. 15 shows similar performance as the acid experiment, with slightly lower cell voltage during the charging step. During discharging, the voltage profile exhibits a plateau in the voltage range between 0.8 to 0.2 V, indicating a faradaic reaction at the surface of platinum electrode, most related to PtOx formations.

The above experiments show that safe, controlled, and separate production and collection of hydrogen and oxygen was possible in a system as herein disclosed.

A significant advantage of the system according to the present disclosure is that the simultaneous use of both alkaline and acidic electrolytes makes it possible to optimize both the hydrogen evolution reaction and the oxygen evolution reaction, improving the kinetics and the efficiency of the system. For example, the potential for the reactions can be adjusted according to the pH, following the Nernst equation.

Additionally, using alkaline and acidic electrolytes in separate reactors significantly reduces the risk of side reactions, such as oxygen evolution in the cathodic reactor, or hydrogen evolution in the anodic reactor. Thus the formation of potentially dangerous mixtures of gases can be avoided, leading to improved safety.

The reduced energy consumption is another important advantage of the system according to the current disclosure. Practical experiments as well as theoretical estimates indicate that the cell voltage is reduced from 1.23 V down to 0.404 V for highly acidic and alkaline electrolytes.

Another advantage is that no molecular separation membranes are needed. Thus, the disadvantages of such membranes, e.g. their cost and the issue of aging and the subsequent need for replacements, can be avoided.

Yet another advantage is that the use of different electrolytes makes it possible to optimize the electrode materials. One electrode can be chosen solely based on its performance in alkaline media, and the other based on its performance in acidic media. It also becomes possible to use less expensive carbon electrodes.

Without further elaboration, it is believed that a person skilled in the art can, using the present description, including the examples, utilize the present invention to its fullest extent. Also, although the invention has been described herein with regard to its preferred embodiments, which constitute the best mode presently known to the inventors, it should be understood that various changes and modifications as would be obvious to one having the ordinary skill in this art may be made without departing from the scope of the invention which is set forth in the claims appended hereto.

Thus, while various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

### REFERENCES

Dotan, H., Landman, A., Sheehan, S. W. et al.: Decoupled hydrogen and oxygen evolution by a two-step electrochemical-chemical cycle for efficient overall water splitting. Nat Energy 4, 786-795 (2019). https://doi.org/10.1038/s41560-019-0462-7
Symes, Mark D, and Cronin, Leroy: Decoupling hydrogen and oxygen evolution during electrolytic water splitting using an electron-coupled-proton buffer, Nature Chemistry, Vol. 5, May 2013, 403-409 (DOI:10.1038/NCHEM.1621)
Yan, X., Biemolt, J., Zhao, K. et al.: A membrane-free flow electrolyzer operating at high current density using earth-abundant catalysts for water splitting. Nat Commun 12, 4143 (2021).

1. An electrochemical system comprising
at least one half-cell (1, 100) adapted for holding an electrolyte, an electrocatalyst (10) arranged on a current collector (11) forming a working electrode, and an auxiliary electrode material (12) arranged on another current collector (13) forming an auxiliary electrode;
wherein the working electrode and the auxiliary electrode are connected to a power supply (300) and a control unit (400), forming a closed circuit, said system further comprising an at least one electrolyte reservoir (130), adapted for holding said electrolyte, at least one pump (140) for circulating said electrolyte between said half-cell (1, 100) and said reservoir (130), and at least one container (150) for collecting gas formed in the electrolytic half-cell.

2. An electrochemical system comprising
a first half-cell (1, 100) adapted for holding a first electrolyte, a first electrocatalyst (10) arranged on a current collector (11) forming a first working electrode, and a first auxiliary electrode material (12) arranged on a second current collector (13) forming a first auxiliary electrode; and
a second half-cell (2, 200) adapted for holding a second electrolyte, a second electrocatalyst (20) arranged on a current collector (21) forming a second working electrode, and a second auxiliary electrode material (22) arranged on a current collector (23) forming a second auxiliary electrode;
wherein the working electrodes are connected to an external circuit including a power supply (300), and a control unit (400), and the auxiliary electrodes are connected to each other, forming a closed circuit, said system further comprising at least a first (130) and second electrolyte reservoir (230), a first (140) and a second (240) pump for circulating a first electrolyte between said first half-cell (1, 100) and said first reservoir (130), and circulating a second electrolyte between said second half-cell (2, 200) and said second reservoir (230), and a first (150) and a second (250) container for collecting gas formed in each electrolytic half-cell respectively.

3. The electrochemical system according to claim 1, wherein said system comprises at least one conduit or bypass (170, 270) for diverting gas formed during the decharging phase.

4. A method for electrochemical production of a gas in an electrochemical system according to claim 1, wherein an electrolyte is pumped into said at least one half-cell and circulated between a half-cell and a reservoir, voltage is applied to at least one working electrode, and gas formed in said electrolyte is separated and collected.

5. The method for electrochemical production of at least one gas in an electrochemical system according to claim 2, wherein two electrolytes are circulated separately between a first reservoir and a first half-cell and a second reservoir and a second half-cell respectively, and a gas evolving in a first electrolyte and a gas evolving in the second half-cell are collected separately.

6. The method according to claim 4, wherein the two electrolytes are maintained at different pH.

7. The method according to claim 4, wherein the gas produced by the method is a gas chosen from hydrogen, chlorine, oxygen and fluorine.

8. The method according to claim 4, wherein the gas produced by the method is hydrogen.

9. A method of separately and alternatingly producing hydrogen and oxygen using a system according to claim 1.

10. A method of producing hydrogen and oxygen in parallel using a system according to claim 2.

11. The method according to claim 10, wherein the cells are operated intermittently to produce oxygen and hydrogen, and wherein the mixing of hydrogen and oxygen is prevented by collecting gas formed during the decharging phase separately from gas formed during the charging phase.

12. The electrochemical system according to claim 2, wherein said system comprises at least one conduit or bypass (170, 270) for diverting gas formed during the decharging phase.

13. The method for electrochemical production of at least one gas in an electrochemical system according to claim 3, wherein two electrolytes are circulated separately between a first reservoir and a first half-cell and a second reservoir and a second half-cell respectively, and a gas evolving in a first electrolyte and a gas evolving in the second half-cell are collected separately.
